(19) United States
(12) Patent Application Publication
(10) Pub. No.: US 2008/0010165 A1
(43) Pub. Date: Jan. 10, 2008

(54) Method and system for the self-organization of purchasing communities

(75) Inventors: Stefan Aschoff, Bubenreuth (DE); Jorg Bindner, Weisendorf (DE)

Correspondence Address: Siemens Corporation;Intellectual Property Department, 170 Wood Avenue South, Iselin, NJ, 08830, US

(73) Assignee: Siemens Audiologische Technik GmbH

(21) Appl. No.: 11/825,178

(22) Filed: Jul. 5, 2007

Related U.S. Application Data
(60) Provisional application No. 60/818,650, filed on Jul. 5, 2006.

(51) Int. Cl. G06Q 30/00

(52) U.S. Cl. 705/26

(57) ABSTRACT

The aim is to provide a system and a method which purchasing communities can use to organize themselves better. To this end, provision is made for one or more manufacturers to stipulate at least one supply unit. A plurality of customers organize themselves in at least one virtual room. The supply unit is finally presented via a data network in the virtual room. This allows the purchasers to benefit from increased discounts and allows the manufacturers to generate additional sales.

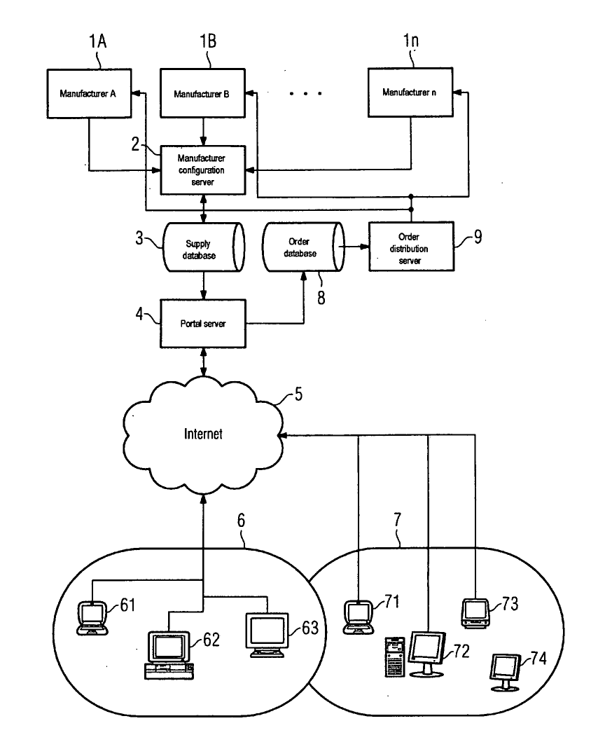

### CROSS REFERENCE TO RELATED APPLICATIONS

The present application claims the benefit of the provisional patent application filed on Jul. 5, 2006, and assigned application No. 60/818,650 which is incorporated by reference herein in its entirety.

### FIELD OF THE INVENTION

The present invention relates to a system for the self-organization of purchasing communities, particularly for hearing instruments. In addition, the present invention relates to an appropriate method for the self-organization of purchasing communities.

### BACKGROUND OF THE INVENTION

At present, hearing instruments, particularly hearing aids, are not normally traded over the Internet. Rather, they are usually traded over the telephone.

For purchasing hearing instruments, there are purchasing groups in which a respective plurality of individual businesses have organized themselves to form a group with a relatively high volume of turnover. In some cases, electronic order forms are already being used. This involves Internet protocol based communication methods being used between a PC on the consumer side and the manufacturer. However, the orders continue to be primarily manual work.

In addition, purchasing groups organize themselves with intensive communication. Such groups are organized at the initiative of consumers. There is no technical support or standardized tools for the self-organization of purchasing groups, however. Furthermore, purchasing groups have only a barely standardized product portfolio with little volume.

### SUMMARY OF THE INVENTION

The object of the present invention is therefore to provide better support for the self-organization of purchasing communities with appropriate aids.

The invention achieves this object by means of a system for the self-organization of shopping communities for hearing instruments having a manufacturer configuration server which one or more manufacturers can use to stipulate at least one supply unit, a portal server which is connected to the manufacturer configuration server and which can be used to present the at least one supply unit, at least one virtual room in which a plurality of customers can organize themselves, and a data network which connects the at least one virtual room to the portal server.

The invention also provides a method for the self-organization of purchasing communities for hearing instruments through stipulation of at least one supply unit by one or more manufacturers, organization of a plurality of customers in at least one virtual room, and presentation of the at least one supply unit via a data network in the at least one virtual room.

Advantageously, the system and the method based on the present invention allow greater discounts to be achieved from the point of view of the consumer. From the point of view of the manufacturer, the discounts can be given in organized and structured form, and also sales can be stimulated.

Preferably, the manufacturer configuration server in the inventive system can be used to stipulate a plurality of supply packages with hearing instruments as a supply unit. This provides the manufacturers with a platform for placing their hearing instruments on the market. In particular, a supply unit may be a hearing aid package for comparative adjustment in which a plurality of manufacturers respectively supply at least one hearing aid for adjustment to suit a customer. This complies with legislative stipulations according to which comparative adjustment needs to be performed.

In line with one advantageous refinement, the supply unit in an inventive system or method relates to a time-based volume of turnover. This allows specific discounts to be exercised on the basis of turnover.

In addition, supply units can also relate to accessories for one or more hearing aids. This means that, in principle, it is possible to combine in a supply unit not only a hearing aid but also any other products of a different product type, particularly also from other manufacturers.

If appropriate, the manufacture configuration server and the portal server may be physically situated on a common computer.

### BRIEF DESCRIPTION OF THE DRAWINGS

The present invention is now explained in more detail with reference to the appended drawing, which shows a block diagram of a system based on the invention.

### DETAILED DESCRIPTION OF THE INVENTION

The exemplary embodiment outlined in more detail below is a preferred embodiment of the present invention.

As the figure shows, a plurality of manufacturers 1A, 1B, . . . , 1n are connected to a manufacturer configuration server 2. There, they can put together various supply packages alone or together. These are finally stored in a supply database 3. A portal server 4 presents the items supplied for customers. It is therefore used to show the supply packages from the point of view of the customer, whereas the manufacturer configuration server 2 is used to show or to create the supply packages from the point of view of the manufacturer.

The items supplied which are presented by the portal server 4 are then forwarded to purchasing communities 6, 7 via the Internet 5 or any other data network. For the sake of clarity, the figure shows only two purchasing communities. However, there may also be just one purchasing community or any higher number of purchasing communities. The first purchasing community 6 contains three customers 61, 62 and 63 in this case. Similarly, the second purchasing community 7 contains the customers 71, 72, 73 and 74. Each of these purchasing communities 6, 7 is a virtual group which has got together in a “virtual room” to form an interest community.

Within a purchasing community, the purchases and enquiries are bundled or channeled and arrive at the portal server 4 with the sender of the respective purchasing community. A bundled enquiry from one of the virtual purchasing communities is forwarded via the Internet 5 and the portal server 4 to an order database 8 and is stored. This database is accessed by an order distribution server 9 which sends the orders to the respective manufacturers 1A, 1B, . . . , 1n.

The trade portal illustrated above thus allows a quota of hearing instruments or hearing aids, possibly organized thematically, to be provided. As a specific example, a supply package may be a “hearing aid package for comparative adjustment” which respectively contains five behind-the-ear hearing aids from a plurality of manufacturers. The quota comprises fifty of these packages. The starting price is fixed. For every package purchased, the price is reduced by 0.1%.

Providing an infrastructure having virtual rooms for individual appearance, having thematically organized product quotas and appropriate marketing platforms (marketing investments) allows an effective aid to be provided for the self-organization of purchasing groups. By way of example, the supply packages can also be formed for the following subjects: “six monthly turnover”, “most popular accessory”, “six monthly consumables package (batteries, printing material, etc.)”, “new exhibition products”, “children's package”, etc.

The purchasing community can jointly send orders for all or some of the members. Alternatively, all individual members can send individual orders to the manufacturers via the system.

Advantageously, the inventive trade portal provides the purchaser with the impression that he has purchased with significant discounts. The reason for this is, inter alia, that the purchasing communities have access to price models which a single business cannot have on its own. In addition, the trade portal can be combined with other marketing promotions, such as partner preference programs, frequent user programs, marketing material, consultancy service, market studies, Internet seminars (webinars) etc. The manufacturer thus benefits from cross-selling opportunities and cross-promotion between a plurality of brand companies, a plurality of product families and products from a plurality of performance classes. For acoustic engineers, for example, it is thus possible to put together packages with hearing aids from different manufacturers and/or hearing aids on different price levels.

Similarly, what are known as “separees” can be set up for already existing purchasing communities or business chains. In these separees it is possible to install the same principle with limited access and individualized offers and price lists.

As a specialty, it is possible to introduce the supply of accessories which are expensive when purchased in a shop at an individual price because of the high fixed costs. When they are supplied in a quota, however, it is possible to provide large discounts on account of the synergic effects.

In addition, the inventive trade portal allows hearing aids from a first manufacturer, for example, to be combined with hard-of-hearing telephones from a second manufacturer and cleaning material for hearing instruments from a third manufacturer to form a package. This provides the purchaser with additional benefit, so that the attractiveness of such packages increases.

1. A system for organizing a shopping community for a hearing instrument, comprising:
a manufacturer configuration server that is used by a manufacturer of the hearing instrument to stipulate a supply unit;
a portal server connected to the manufacturer configuration server that presents the supply unit;
a virtual room where a plurality of customers organize themselves into the shopping community; and
a data network that connects the virtual room to the portal server.

2. The system as claimed in claim 1, wherein the supply unit comprises a plurality of supply packages of the hearing instrument.

3. The system as claimed in claim 1, wherein the supply unit comprises a time-based volume of turnover.

4. The system as claimed in claim 1, wherein the supply unit comprises an accessory of the hearing instrument.

5. The system as claimed in claim 1, wherein the supply unit is a hearing aid package for comparatively adjusting a plurality of hearing aids according to the customers.

6. The system as claimed in claim 5, wherein the hearing aids are respectively supplied by a plurality of manufacturers.

7. The system as claimed in claim 1, wherein the hearing instrument is a hearing aid.

8. The system as claimed in claim 1, wherein the manufacturer configuration server and the portal server are arranged on a single computer.

9. A method for organizing a shopping community for a hearing instrument, comprising:
stipulating a supply unit by a manufacturer of the hearing instrument;
organizing a plurality of customers into the shopping community via a virtual room; and
presenting the supply unit via a data network in the virtual room.

10. The method as claimed in claim 9, wherein the shopping community is organized by the customer themselves.

11. The method as claimed in claim 9, wherein the supply unit comprises a plurality of supply packages of the hearing instrument.

12. The method as claimed in claim 9, wherein the supply unit comprises a time-based volume of turnover.

13. The method as claimed in claim 9, wherein the supply unit comprises an accessory of the hearing instrument.

14. The method as claimed in claim 9, wherein the supply unit is a hearing aid package for comparatively adjusting a plurality of hearing aids according to the customers.

15. The method as claimed in claim 14, wherein the hearing aids are respectively supplied by a plurality of manufacturers.

16. The method as claimed in claim 9, wherein the hearing instrument is a hearing aid.
